(19) United States
(12) Patent Application Publication
(10) Pub. No.: US 2005/0010581 A1
(43) Pub. Date: Jan. 13, 2005

(54) Method for identifying composite data types with regular expressions

(75) Inventor: Khanh Phi Van Doan, Noranda (AU)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/846,117

(22) Filed: May 14, 2004

(30) Foreign Application Priority Data
May 16, 2003 (AU) 2003902388

(51) Int. Cl. G06F 17/00

(52) U.S. Cl. 707/100

(57) ABSTRACT

Disclosed is a method of identifying data format information. A regular expression described in schema is matched with data sub-formats. From the matching, a ‘type’ of the regular expression is then identified. More specifically, a regular expression tree is constructed (5001) from the regular expression. At least one sub-format of the data format is then identified, the sub-format comprising at least one constituent part. Each constituent part of each sub-format is represented (5002) with a corresponding Finite State Machine, each Finite State Machine comprising an entry point, an exit point and at least one state. The regular expression tree is then matched (5003, 5004) against the Finite State Machines to identify a matching one of the, sub-formats, the one sub-format thereby representing the data format of the regular expression.

### CROSS-REFERENCE TO RELATED PATENT APPLICATIONS

This application claims the right of priority under 35 U.S.C. § 119 based on Australian Patent Application No. 2003902388, filed 16 May 2003, which is incorporated by reference herein in its entirety as if fully set forth herein.

### COPYRIGHT NOTICE

This patent specification contains material that is subject to copyright protection. The copyright owner has no objection to the reproduction of this patent specification or related materials from associated patent office files for the purposes of review, but otherwise reserves all copyright whatsoever.

### TECHNICAL FIELD OF THE INVENTION

The present invention relates to the automated analysis of data and, in particular, to the automatic detection of composite data types from schema information containing regular expressions.

### BACKGROUND

XML (Extensible Markup Language) is increasingly becoming a popular format for storing and exchanging information. XML is a tree-structured data format consisting of a root element with sub-elements, each of which may in turn comprise sub-elements of its own. Optionally associated with each element of an XML tree is an element or node value. Also optionally associated with each element is one or more attributes, each having an attribute value.

The structure of an XML tree is usually defined in an XML schema. The schema dictates, amongst other things, the format or data type of each element and attribute value in the XML tree. Standard data types include Boolean, numeric, date, or string. The latter can be a free format string, or a restricted string with a limited range or set of values.

When a specialised element or attribute value does not fall into one of the pre-defined formats, it is often necessary to define that value as a restricted string data type in the schema. For example, if a data value comprises a number and a unit of measurement, such as 100 km or $100, then the “numeric” data type is unsuitable because it does not permit the presence of unit information, whilst the free format “string” data type is not sufficiently specific because it permits use of any string.

The XML Schema (see http://www.w3.org/XML/Schema) recommendation defines two basic methods of restricting the values of a string. The first specifies enumerations to which the string must belong and the second specifies patterns to which the string must conform. The first identifies actual permissible string values whilst the second declares generalised patterns for the string. These patterns are specified in the XML schema using a format similar to standard regular expression formats well known to those familiar with data formats and the like.

It is often advantageous to be able to deduce from an XML schema definition the type or format of a value of an element or attribute. This is because typically, many XML data elements and attributes share the same schema definition, while tags in an XML document are not generalised, and hence only a single examination of the definition is necessary to determine the data types of all of its associated data. Further, schema definitions are often made available prior to the creation of the actual data itself. For example, a body of organisations may collectively agree upon a common schema to which all of their subsequent data publications will adhere. Being able to analyse the schema enables the format of future data to be deduced in advance.

When working with a restricted string data type, the determination of the data format requires an analysis of its enumerations and patterns. The analysis of the enumeration is relatively simple and is effectively no different to determining the format from an actual data string. The analysis of the patterns is considerably more difficult. Consider the scenario of determining whether a schema string pattern defines a valid currency data value. Different currencies and formats are permitted, for example, −$100, US$1, AUS$1mil, £1.34 billion, 99¢, etc . . . Some possible examples of currency patterns are shown in Table 1.

TABLE 1
Examples of Currency Patterns.

| Pattern: | Comment |
|---|---|
| “$/d” | $ followed by any digit |
| “(+\|−)$/d” | + or − sign followed by $ followed by any digit |
| “[+−]$/d” | + or − sign followed by $ followed by any digit |
| “US$/d+” | US$ followed by one or more digits |
| “A?(US)?$/d+” | Optionally one of A, US or AUS, followed by $ and |
| | followed by one or more digits |
| “1./d+” | 1 followed by ‘.’ and followed by one or more digits |
| “£/d{1;8} | £ followed by 1 to 8 digits, and followed by “mil” or |
| (mil\|million)” | “million” |
| “$/d+(./d+)?” | $ followed by 1 or more digits, and then optionally |
| | followed by ‘.’ and 1 or more digits |
| “($\|£1)/d+” | $ or £1 followed by 1 or more digits |

In general a regular expression or XML string schema pattern can be represented by a Finite State Machine (FSM), and the problem of determining the corresponding data format can be viewed as a problem of matching this first FSM against other FSMs, each representing a known data format. If the set of legal string outputs produced by the first FSM can be shown to be subsumed by that produced by one of the other FSMs, then the data format of the regular expression or schema pattern is identified.

Unfortunately the problem of matching FSMs is in general intractable, and thus no efficient process exists for determining whether a regular expression or schema pattern is guaranteed to represent or not represent a given data format. The last pattern in Table 1 illustrates the reason for the intractability: there may in general be no clear demarcation within a pattern where one sub-pattern ends and another sub-pattern begins. This last pattern cannot be partitioned into a sub-pattern representing a currency sign and a second sub-pattern representing a number.

As a result of the difficulty in matching schema patterns, existing systems do not attempt to analyse patterns when they are present in schemas. Instead, all string data types are either treated as representing generic (or free format) text strings, or actual data only is analysed to determine the formats. Consequently these systems do not make full use of the available information and hence do not operate in the most optimal fashion.

### SUMMARY OF THE INVENTION

It is an object of the present invention to substantially overcome, or at least ameliorate, one or more disadvantages of existing methods.

Disclosed herein is a method for automatically analysing a regular expression or XML string schema pattern to determine the format of the associated data. The method makes use of the inventor's important observation that, although possible, patterns that do not comprise cleanly partitioned sub-patterns, such as the last example in Table 1, are unlikely to occur in practice. Those patterns that can be cleanly partitioned are more likely since they are easier to synthesise by their (human) creators. Such patterns can be created by simply concatenating together sub-patterns representing different parts of data. Further there is usually little reason to do otherwise. In the previous currency example, one simply takes a pattern for a number and concatenates it with various possible patterns for currency.

The present inventor has taken advantage of this fact to produce an efficient analysis process or method. The method determines whether or not a pattern represents a given composite data type, for example, numeric data with associated dimensions or quantities, by only searching for cleanly demarcated sub-patterns that represent different constituent parts of the data type. Since this covers all likely patterns, the approach can provide an accurate as well as efficient analysis of the schema.

In accordance with one aspect of the present invention there is disclosed a method of identifying data-format information. The method includes matching a regular expression described in schema with data sub-formats. Based on the result of the matching a ‘type’ of the regular expression can then be identified.

In accordance with another aspect of the present invention there is disclosed a method of identifying data format information from a regular expression. A regular expression tree is constructed from the regular expression. At least one sub-format of the data format is identified, the sub-format comprising at least one constituent part. Each constituent part of the at least one sub-format is represented with a corresponding Finite State Machine, each Finite State Machine comprising an entry point, an exit point, at least one state and preferably zero or more transitions. The regular expression tree is then matched against the Finite State Machines to identify a matching one of the sub-formats, the one sub-format thereby representing the data format of the regular expression.

Numerous other aspects of the present invention are also disclosed.

### BRIEF DESCRIPTION OF THE DRAWINGS

At least one embodiment of the present invention will now be described with reference to the drawings in which

FIG. 1 is an example regular expression tree;

FIG. 2 is an example of a finite state machine (FSM) representing a number;

FIG. 3 is an example of a regular expression tree undergoing a flattening operation;

FIGS. 4A and 4B are flowcharts of the state sequence pair propagation procedure;

FIG. 5 is a flowchart of the overall procedure for determining whether a regular expression tree represents a given data format;

FIGS. 6A and 6B are flowcharts of the procedure for matching sub-patterns in a flattened regular expression tree against a given data format;

FIG. 7 is another example regular expression tree;

FIG. 8 is a simplified FSM representing a unit weight;

FIG. 9 is a schematic block diagram representation of a computer system upon which the embodiments described can be practiced; and

FIG. 10 is an example FSM representing a fixed number format.

### DETAILED DESCRIPTION INCLUDING BEST MODE

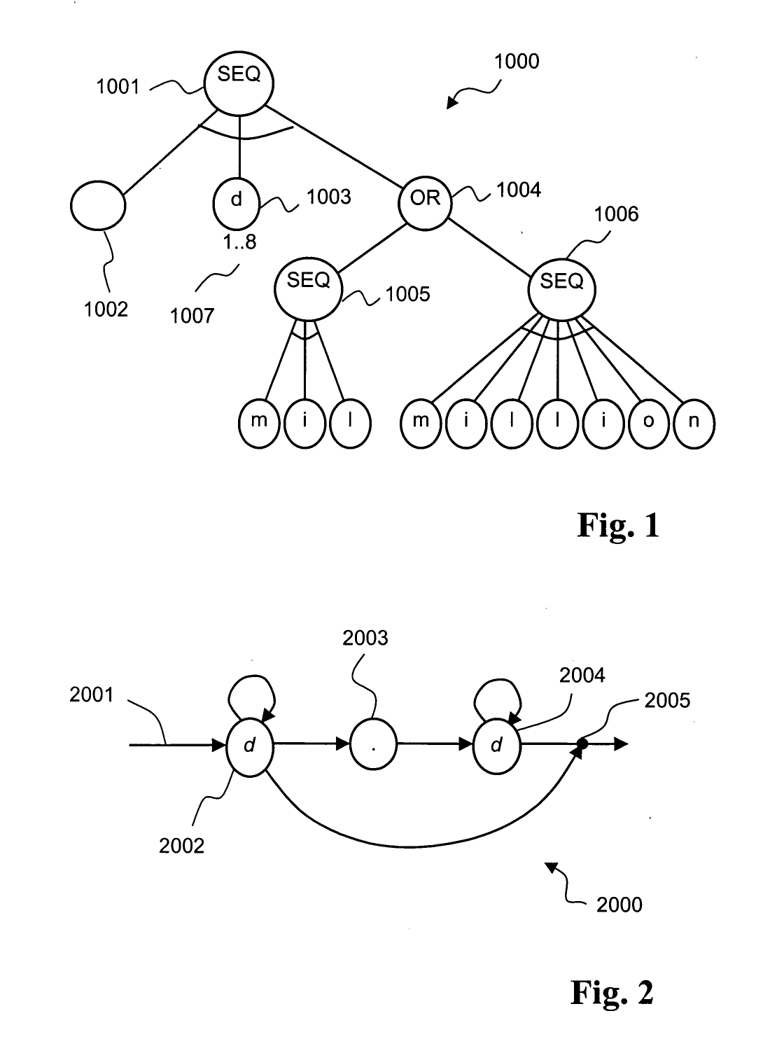

An XML string schema pattern is a regular expression specifying the characters that can appear in a data string, their ordering and number of appearances. Although the schema pattern can be represented as a FSM, a more convenient and efficient representation format is a regular expression tree, which can be obtained using readily available regular expression parsing methods. An example regular expression tree 1000 for the pattern “£/d{1;8}(mil|million)” is shown in FIG. 1.

Each leaf node in the regular expression tree 1000 represents or instantiates to a single character in the actual data string. In FIG. 1, an italic “d” shown at node 1003 represents any numeric digit. A non-leaf node on the other hand typically represents a character string. Both leaf and non-leaf nodes may be instantiated multiple times by associating with a minimum and a maximum number of instances. These values 1007 are shown below a node and indicate the range of allowable instances of the character string produced by the node. The string can include one or more characters. Further, the instances may be repetitions. When the range of allowable instances of a node is restricted to an exact number, a single numerical value is usually shown below the node (not shown in FIG. 1). If no such value is shown then the number of instances is 1. From FIG. 1, between 1 and 8 instances of a numeric digit 1003 are permitted.

For example, in order to represent a number having the fixed form dd,ddd.dd, a FSM such as that shown in FIG. 10 may be used. Each value for d may be any numeral from 0 to 9. The FSM of FIG. 10 may be used to represent a monetary amount such as $25,100.37 noting that the $ symbol has been omitted from FIG. 10 for clarity.

There are two types of non-leaf nodes: SEQ nodes 1001, 1005 and 1006, and an OR node 1004. A “sequence” (SEQ) node indicates that the data string must match the sub-patterns represented by the immediate child nodes in sequence, from left to right. An OR node on the other hand indicates that the data string can match any one of the child nodes. Like other nodes, a SEQ or OR node can also have an associated instance number or range. For example, if node 1005 in FIG. 1 has an associated instance number range of 1 . . . 3, then the subtree rooted at this node can generate any of the strings “mil”, “milmil” and “milmilmil”.

To determine whether a regular expression tree represents a particular data format, it is necessary to verify that all possible strings matching the regular expression are legal instances of the given data format. Each data format is usually defined as one or more alternative concatenations of smaller constituent parts or entities, some of which are compulsory whilst others may be optional. Each alternative concatenation is referred to as a sub-format. For example, the following are two sub-formats of currency data made up of constituent parts sign, currency prefix, number, quantity and currency suffix, arranged as follows:

| | |
|---|---|
| [sign](currency prefix)(number)[quantity] | eg. $100, −$5, $1 million |
| [sign](number)(currency suffix) | eg. 99 ¢ |

where rounded brackets indicate compulsory entities and square brackets indicate optional entities.

Each entity or constituent part is represented by a FSM comprising a small number of states and transitions, an entry and an exit point. The behaviour of a FSM is governed by its states and the transitions between them. Each state of the FSM is associated with a single character, a range of characters or a character string. When a state is entered, a character or character string associated with the state is generated.

For example, the number entity representing a valid number can be represented by the FSM 2000 of FIG. 2. The FSM 2000 has an entry point 2001 and an exit point 2005. States 2002 and 2004 each generate any digit from 0 to 9, whilst state 2003 generates a decimal point. The various arrows in FIG. 2 between the entry point 2001 and the exit point 2005 represent transitions between the states 2002, 2003, 2004 and 2005. For example, the looped arrow commencing from the state 2002 and ending on the state 2002 indicates that any number of digits can be present at that location to form a number entity. The states 2003 and 2004 are only used where a decimal number is represented and hence the transition formed by the arrow directly linking the state 2002 with the exit point 2005 is used when only an integer number is being represented.

To facilitate the matching of schema patterns, the concept of state sequence pair is introduced. A state sequence pair is a pair of states in an FSM between which there exists one or more direct or indirect paths originating from the first state and ending in the second state. It is possible for a state sequence pair to have identical starting and ending states. A state sequence pair is said to be joinable with a second state sequence pair if there exists a direct path from the ending state of the first pair to the starting state of the second pair. The result of a join operation between the two pairs is a new state sequence pair whose starting state is the starting state of the first pair and whose ending state is the ending state of the second pair.

As stated earlier, the present disclosure overcomes the intractability problem by observing that most schema patterns comprise cleanly partitioned sub-patterns. The analysis of schema patterns can thus be performed by searching for the partition points and matching individual resulting sub-patterns against different constituent parts of the data format. For the currency example above, this involves searching for sub-patterns representing sign, currency prefix/suffix, number, and quantity, if they exist.

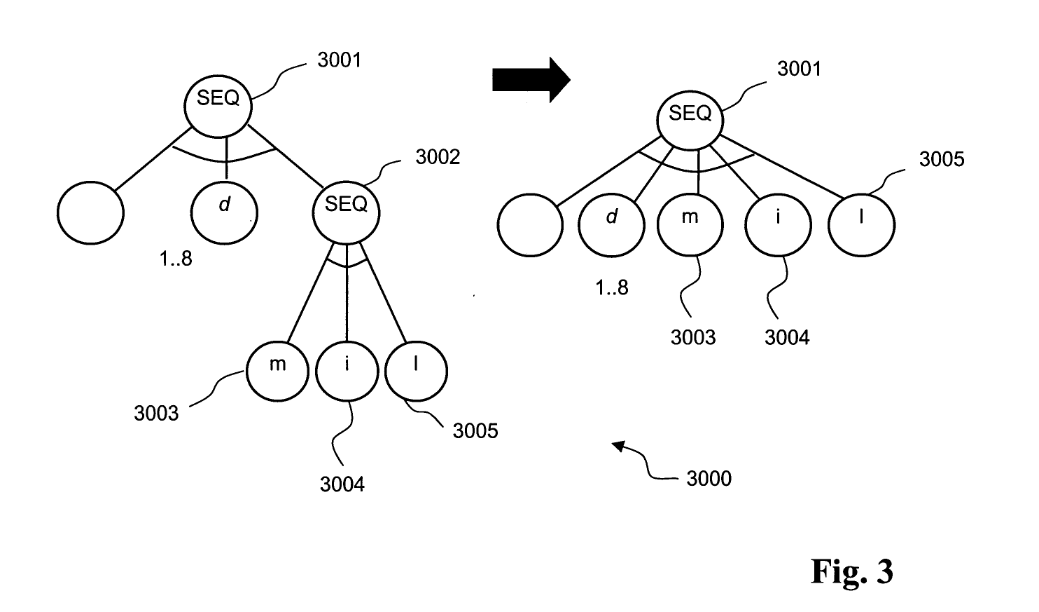

From a regular expression tree, sub-patterns in the original regular expression can readily be identified. If the root node is a SEQ node, as in FIG. 1, then each of its children represents a sub-pattern. For example, in FIG. 1, there are 3 sub-patterns, 1002 representing “£”, 1003 representing one to eight digits, and 1004 representing “mil” or “million”. If a child node of the root SEQ node is itself a SEQ node, then an equivalent flattened tree may be constructed by removing the child SEQ node and promoting its children to be immediate children of the root node. An example of such an operation is shown in FIG. 3, in which nodes 3003-3005 are children of SEQ node 3002 which is itself a child of the root node 3001. As a result of the operation 3000, nodes 3003-3005 are promoted to be immediate children of the root node 3001. The above operation however, is only possible when the instance number associated with the child SEQ node is exactly 1. If one of the promoted nodes is itself a SEQ node, then the flattening operation can be repeated, as long as the above condition is satisfied.

When the regular expression tree is fully flattened, each of the resulting child nodes of the root SEQ node represents a sub-pattern, each or a sequence of which may match a single constituent part of the data format being examined. To determine whether a single sub-pattern or a sequence of sub-patterns matches a constituent part, it is necessary to compile a plurality of lists of all state sequence pairs in the FSMs of all constituent parts that match each sub-pattern. A state sequence pair is said to match a sub-pattern if there exists:
(i) an output string matching the sub-pattern; and
(ii) any path in the corresponding FSM beginning at the start node of the state sequence pair and ending at the end node of the state sequence pair matches the same output string.

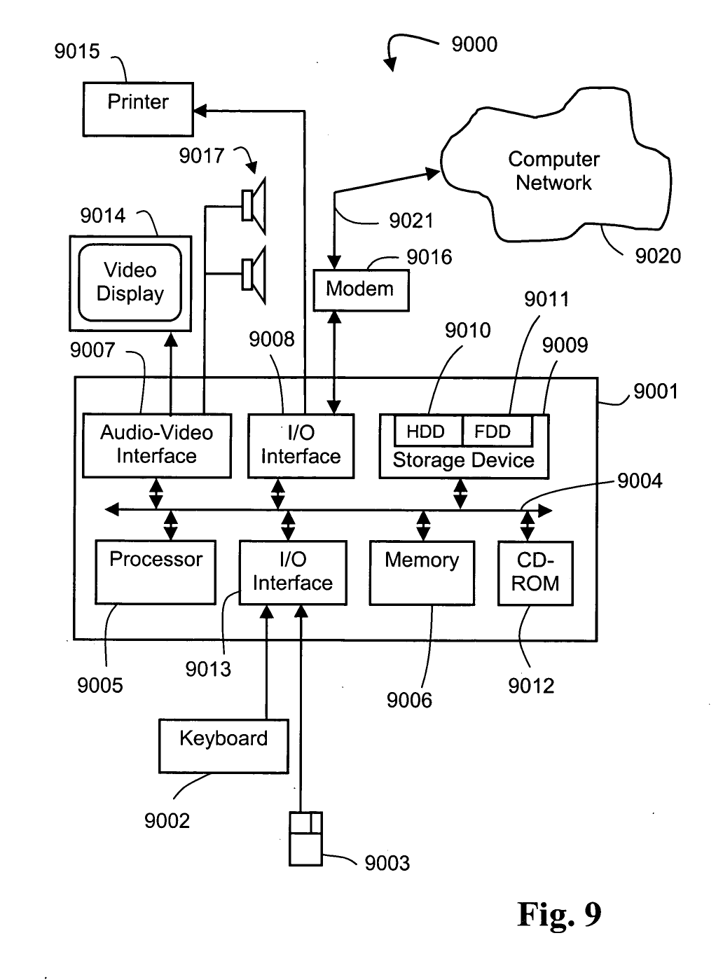

The method of regular expression data format analysis and pattern matching to be described is preferably practiced using a general-purpose computer system 9000, such as that shown in FIG. 9 wherein the processes of FIGS. 1 to 8 may be implemented as software, such as an application program executing within the computer system 9000. In particular, the steps of method of format analysis are effected by instructions in the software that are carried out by the computer. The instructions may be formed as one or more modules of computer program code, each for performing one or more particular tasks. The software code may also be divided into separate parts, in which one part performs the analysis methods and another part manages a user interface between the first part and the user. The software may be stored in a computer readable medium, including the storage devices described below, for example. The software is loaded into the computer from the computer readable medium, and then executed by the computer. A computer readable medium having such software or computer program recorded on it is a computer program product. The use of the computer program product in the computer preferably effects an advantageous apparatus for data format analysis.

The computer system 9000 is formed by a computer module 9001, input devices such as a keyboard 9002 and mouse 9003, output devices including a printer 9015, a display device 9014 and loudspeakers 9017. A Modulator-Demodulator (Modem) transceiver device 9016 is used by the computer module 9001 for communicating to and from a communications network 9020, for example connectable via a telephone line 9021 or other functional medium. The modem 9016 can be used to obtain access to the Internet, and other network systems, such as a Local Area Network (LAN) or a Wide Area Network (WAN), and may be incorporated into the computer module 9001 in some implementations.

The computer module 9001 typically includes at least one processor unit 9005, and a memory unit 9006, for example formed from semiconductor random access memory (RAM) and read only memory (ROM). The module 9001 also includes an number of input/output (I/O) interfaces including an audio-video interface 9007 that couples to the video display 9014 and loudspeakers 9017, an I/O interface 9013 for the keyboard 9002 and mouse 9003 and optionally a joystick (not illustrated), and an interface 9008 for the modem 9016 and printer 9015. In some implementations, the modem 9016 may be incorporated within the computer module 9001, for example within the interface 9008. A storage device 9009 is provided and typically includes a hard disk drive 9010 and a floppy disk drive 9011. A magnetic tape drive (not illustrated) may also be used. A CD-ROM drive 9012 is typically provided as a non-volatile source of data. The components 9005 to 9013 of the computer module 9001, typically communicate via an interconnected bus 9004 and in a manner which results in a conventional mode of operation of the computer system 9000 known to those in the relevant art. Examples of computers on which the described arrangements can be practised include IBM-PC's and compatibles, Sun Sparcstations or alike computer systems evolved therefrom.

Typically, the application program is resident on the hard disk drive 9010 and read and controlled in its execution by the processor 9005. Intermediate storage of the program and any data fetched from the network 9020 may be accomplished using the semiconductor memory 9006, possibly in concert with the hard disk drive 9010. In some instances, the application program may be supplied to the user encoded on a CD-ROM or floppy disk and read via the corresponding drive 9012 or 9011, or alternatively may be read by the user from the network 9020 via the modem device 9016. Still further, the software can also be loaded into the computer system 9000 from other computer readable media. The term “computer readable medium” as used herein refers to any storage or transmission medium that participates in providing instructions and/or data to the computer system 9000 for execution and/or processing. Examples of storage media include floppy disks, magnetic tape, CD-ROM, a hard disk drive, a ROM or integrated circuit, a magneto-optical disk, or a computer readable card such as a PCMCIA card and the like, whether or not such devices are internal or external of the computer module 9001. Examples of transmission media include radio or infra-red transmission channels as well as a network connection to another computer or networked device, and the Internet or Intranets including e-mail transmissions and information recorded on Websites and the like.

The method of data format analysis may alternatively be implemented in dedicated hardware such as one or more integrated circuits performing the functions or sub functions of data format analysis. Such dedicated hardware may include digital signal processors, or one or more microprocessors and associated memories.

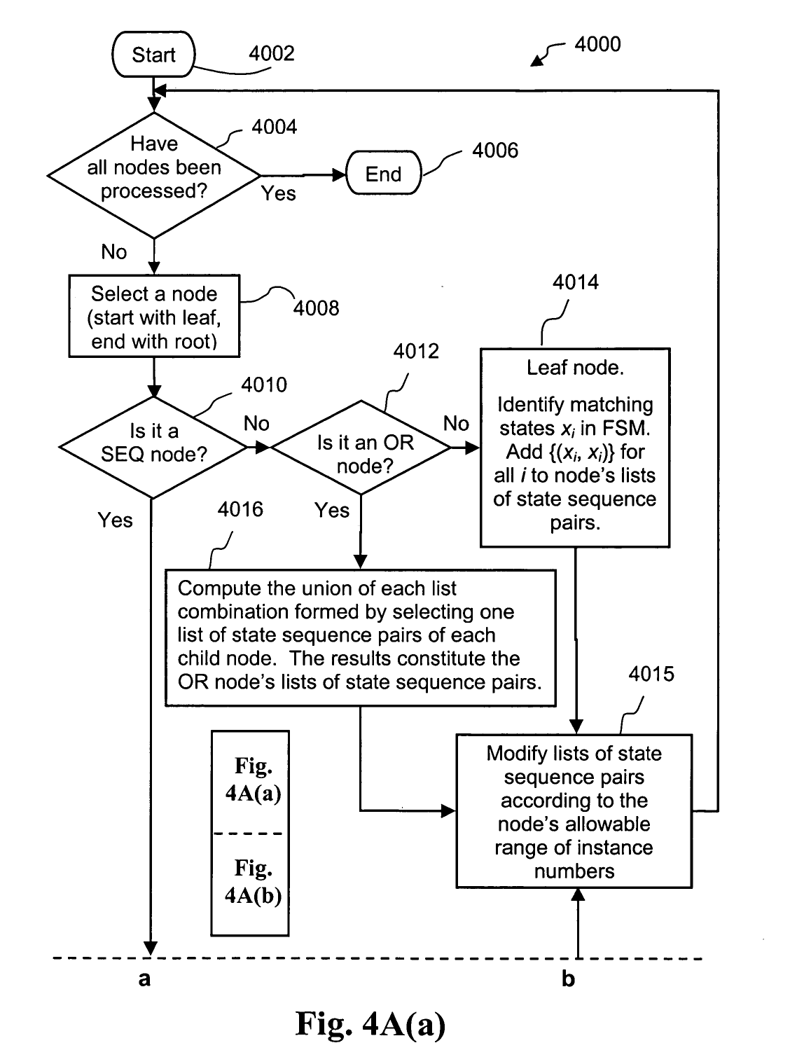

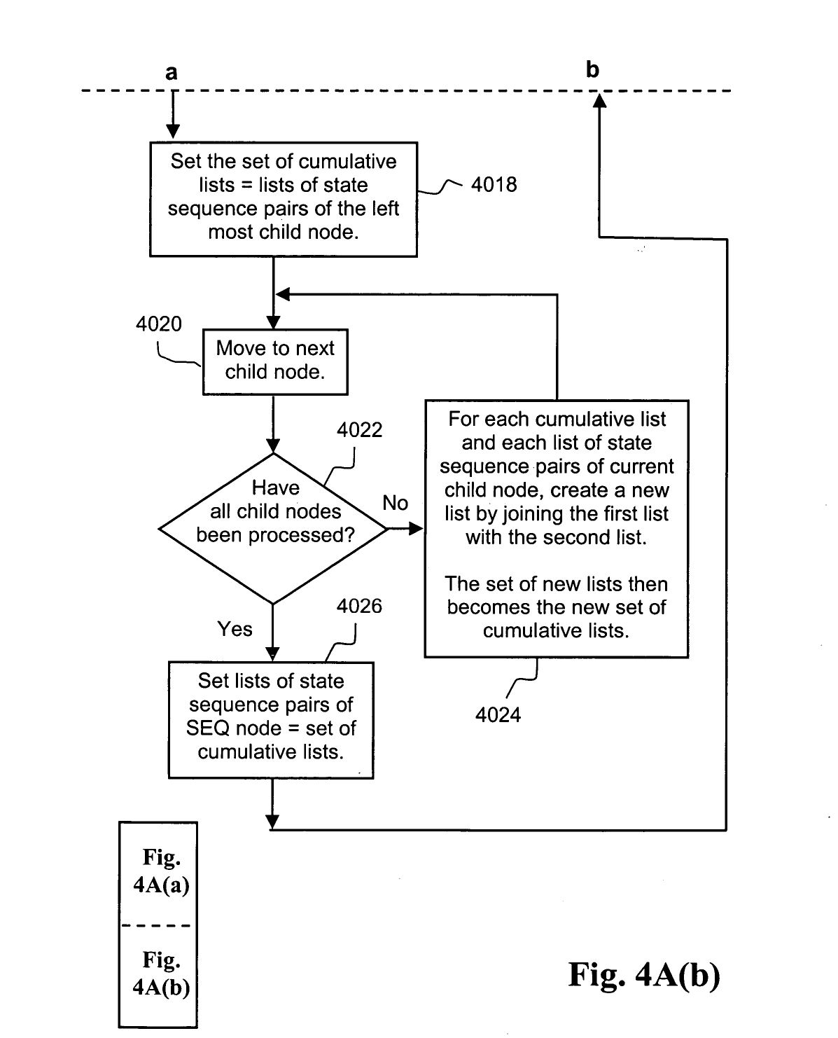

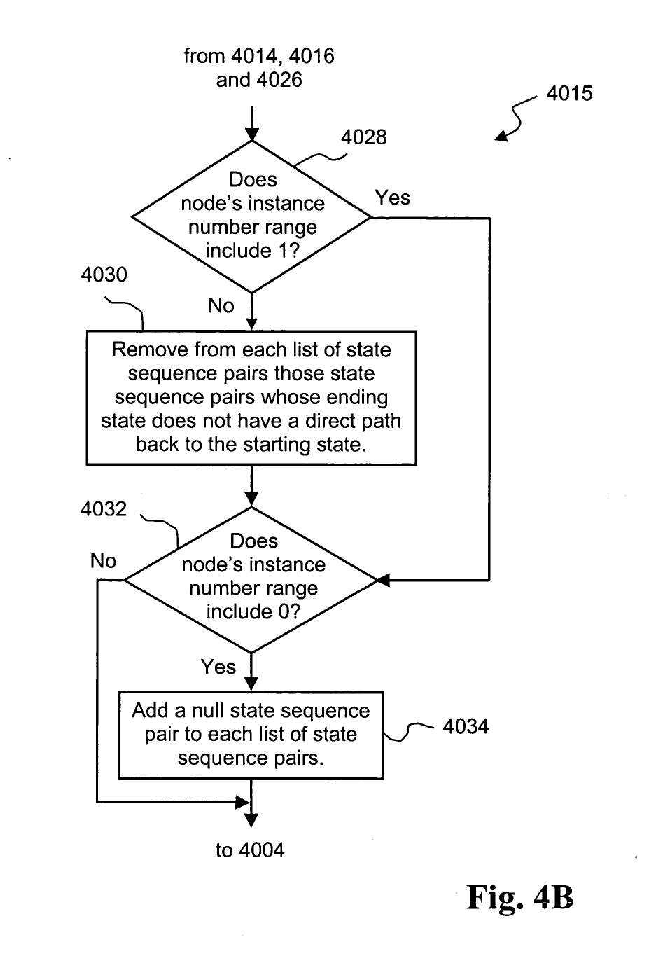

A procedure for computing the lists of state sequence pairs for all nodes, including non-leaf nodes, in a regular expression tree is shown in FIG. 4A and FIG. 4B. The procedure is preferably implemented by an application program able to be run on the computer system 9000 and involves the propagation of state sequence pairs of child nodes of the non-leaf nodes.

FIG. 4A and FIG. 4B show a method 4000 having an entry point 4002 which passes to a decision step 4004 that determines if all nodes in a regular expression tree have been processed. If so, the method 4000 ends at step 4006. If not, step 4008 selects a node from the tree. Preferably, the processing begins at the leaf nodes and proceeds upwards to the root SEQ node.

With the selected node, step 4010 checks if the node is a SEQ node. If not, step 4012 follows to check if it is an OR node. If not, the selected node is a leaf node. For each leaf node, step 4014 identifies all states xᵢ in all FSMs to which the node corresponds, and assigns to the node a list Lsᵢ for each such state comprising a single state sequence pair with xᵢ as the starting and ending state, ie. Lsᵢ={(xᵢ, xᵢ)}. A state in an FSM corresponds to a leaf node in the regular expression tree if there exists a common character generated by both the state and a single instance of the leaf node. Control then proceeds to step 4015 where the lists of state sequence pairs assigned to each node are modified based on the allowable range of instance numbers of the node.

Step 4015 is depicted in detail in FIG. 4B. Step 4015 begins at step 4028 where a check is made to determine if the allowable range of instance numbers associated with the node includes one. If not, then step 4030 follows where the lists of state sequence pairs assigned to the node are reduced by eliminating state sequence pairs whose ending state does not have a direct path leading back to the starting state. In either case, control proceeds to step 4032 where another check is made to determine whether the node's allowable range of instance numbers includes zero. If yes then in step 4034 a null state sequence pair is added to each of the node's lists of state sequence pairs, if it is not already included. A null state sequence pair is a special state sequence pair corresponding to an empty output string. It is joinable with all state sequence pairs, and conversely all state sequence pairs are joinable with it. A join operation involving a null state sequence pair and another state sequence pair p is simply p. Control in either case then returns to step 4004 to check for unprocessed nodes.

Returning to FIG. 4A, for an OR non-leaf node, step 4016 constructs and assigns a list Lsₖ for each and every possible combination formed by selecting one list from each child node, where Lsₖ is the union of the lists in the combination from which it is constructed. Control then proceeds to step 4015.

For a SEQ non-leaf node determined at step 4010, step 4018 subsequently obtains lists of state sequence pairs by combining the lists of state sequence pairs of children of the node, beginning with the left most child and proceeding from left to right. Preferably, a plurality of cumulative lists are maintained. These are initially equated to the lists of state sequence pairs of the left most child. As each subsequent child node is processed via the testing steps 4020 and 4022, step 4024 operates to join each cumulative list with each individual list of state sequence pairs of the child node to produce a new set of cumulative lists. Two lists of state sequence pairs are joined by joining each and every state sequence pair of the first list with each and every state sequence pair of the second list, if the state sequence pairs are joinable. Each state sequence pair of the first list is tested with each state sequence pair of the second list using the FSM to determine if the joinability criterion noted above is satisfied. A joining operation can be successful or unsuccessful. The new cumulative lists arising from the joining operations then replace the existing ones when processing moves to the next child node, again via steps 4020 and 4022.

When all child nodes of a SEQ node have been processed by the above procedure, the final cumulative lists become the lists of the state sequence pairs of the SEQ node. This processing is performed in step 4026 after which control proceeds to step 4015.

Once formed, the lists of state sequence pairs of the inmmediate child nodes of the root node can be used to determine whether the sub-patterns represented by these nodes match one or more constituent parts of the data format. The general idea is that if at least one list of state sequence pairs for a single child node comprises solely state sequence pairs whose starting state is connected to the entry point of the FSM of a constituent part, and whose ending state is connected to the exit point of the same FSM, then the sub-pattern represented by the child node matches the FSM. If at least one list of state sequence pairs comprises solely the null state sequence pair and state sequence pairs whose starting state is connected to the entry point of an FSM and whose ending state is connected to the exit point of the same FSM, then the sub-pattern is said to optionally match the FSM. This more relaxed form of matching is sufficient for constituent parts that are only optionally present in the data format definition.

Similarly, an FSM matches a sequence of child nodes if at least one of their joined lists of state sequence pairs comprises solely state sequence pairs whose starting state is connected to the entry point of the FSM and whose ending state is connected to the exit point of the FSM. As in the case of a single sub-pattern, if at least one of their joined lists comprises solely the null state sequence pair and/or state sequence pairs whose starting state is connected to the entry point of the FSM and whose ending state is connected to the exit point of the FSM, then the sub-pattern sequence is said to optionally match the FSM.

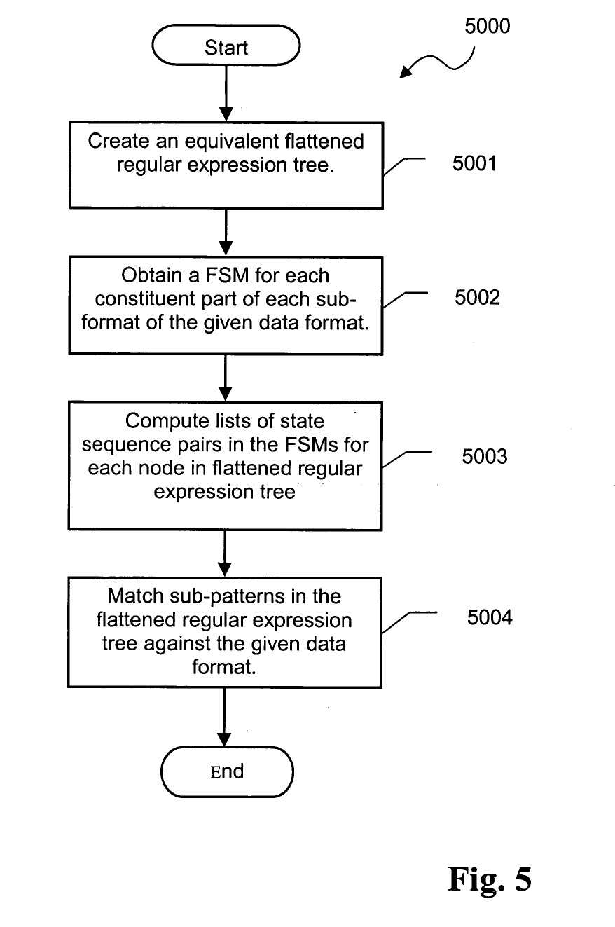

An overall procedure 5000 for determining whether a regular expression tree represents a given data format is shown in FIG. 5. The procedure 5000 may be formed as an independent software application program or incorporated into that previously described with respect to FIGS. 4A and 4B. The procedure 5000 begins at step 5001 where an equivalent flattened regular expression tree is created. At step 5002, a FSM is conceptually obtained for each sub-format of the given data format. Next, step 5003 computes, for each node in the flattened regular expression tree, lists of state sequence pairs in the FSMs, as illustrated by FIG. 4A and FIG. 4B and described in detail earlier. Finally, step 5004 analyses the lists of state sequence pairs to determine whether sub-patterns in the flattened regular expression tree match the given data format.

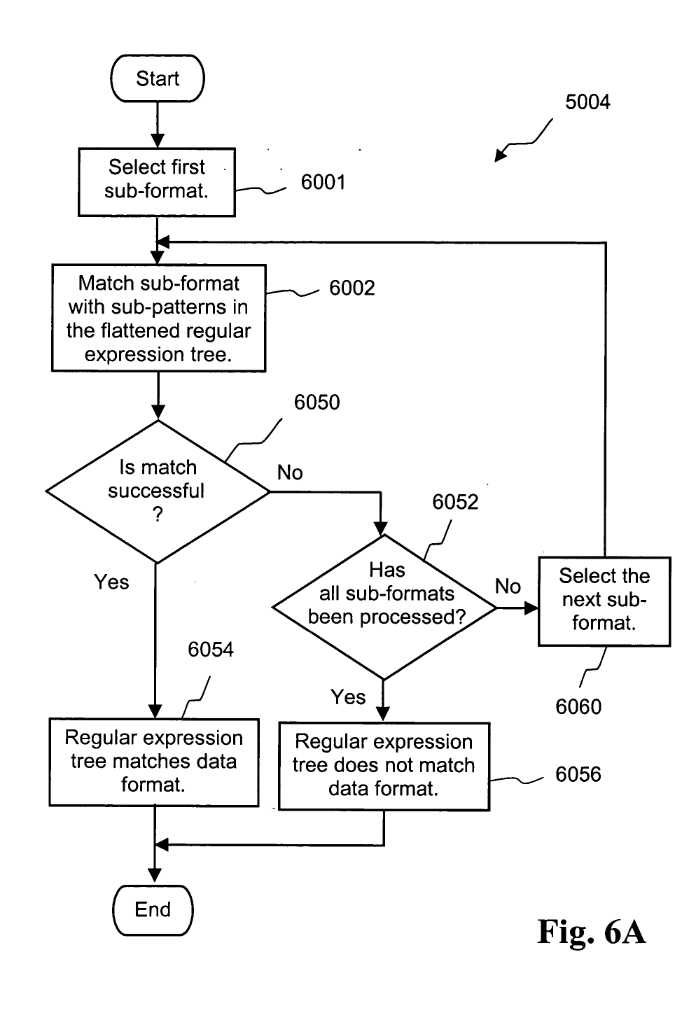

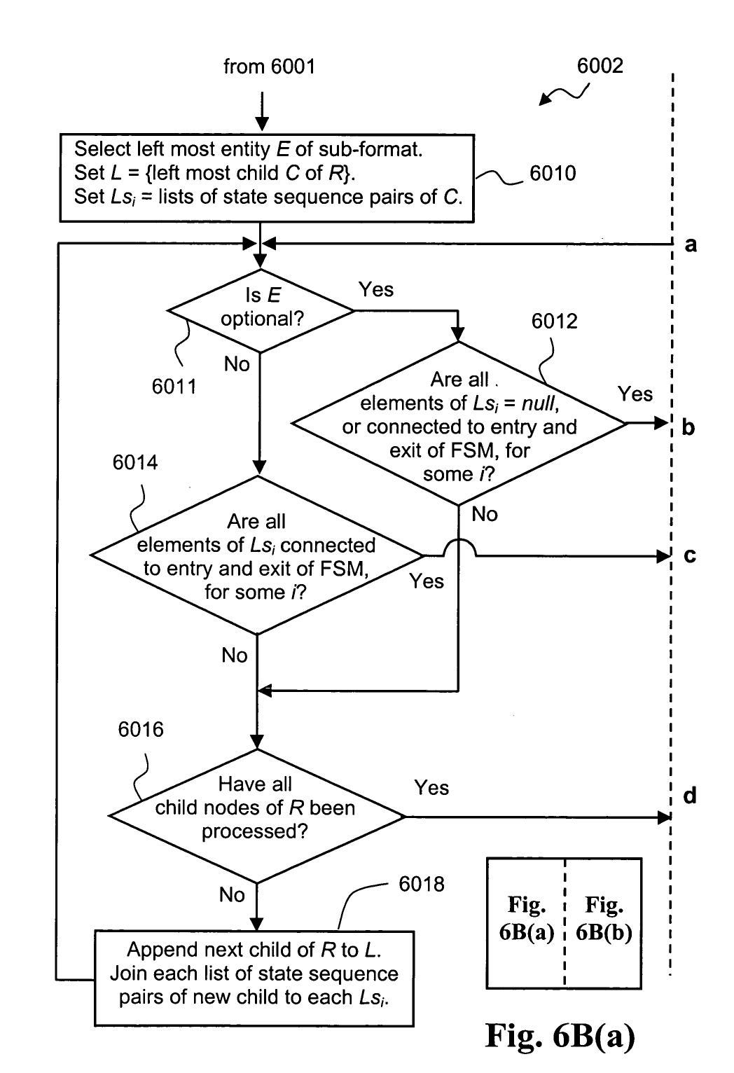

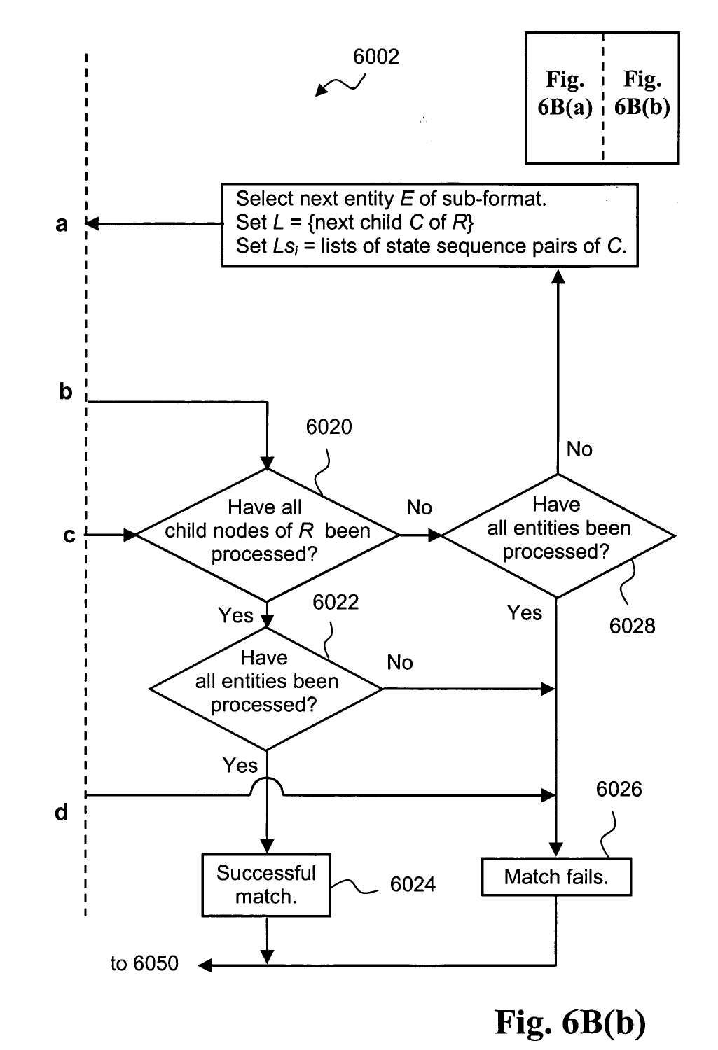

The detailed procedure for the final step 5004 is shown in FIGS. 6A and 6B, where FIG. 6B is an expansion of step 6002 of FIG. 6A. The procedure 5004 is preferably implemented in software on the computer system 9000 and commences at step 6001 by selecting the first sub-format. Step 6002 follows to match the sub-format with sub-patterns in the flattened regular expression tree. Reference is now made to FIG. 6B.

At step 6010 the left-most entity E of the current sub-format is selected and a plurality of lists Lsᵢ of state sequence pairs is initialised with those of the first (left most) child node of the root node R. Also initialised is an ordered list L of nodes to contain solely the left most child node.

If the current entity E is optional, then step 6011 passes to step 6012 which determines whether at least one Lsᵢ comprises solely a null state sequence pair, and/or state sequence pairs whose starting state is connected with the entry point of the FSM of the current entity E and whose ending state is connected with the exit point of the FSM. If this is the case, step 6020 follows, otherwise step 6016 is processed.

If step 6011 determines that the current entity E is compulsory, then step 6014 is performed to determine whether at least one Lsᵢ comprises solely state sequence pairs whose starting state is connected with the entry point of the FSM and whose ending state is connected with the exit point of the FSM. If this is the case, then step 6020 is performed. Otherwise, step 6016 is performed.

Step 6016 determines if all child nodes of the root node R have been processed. If so, then step 6026 operates to identify a failed match. If there are more child nodes, at step 6018, the next child node of the root node R is appended to the list L. Each Lsᵢ is then joined with each list of state sequence pairs of the new child node to produce a new set of lists of state sequence pairs. The previous lists Lsᵢ are replaced with the new lists and step 6011 then follows.

Where the current entity E matches the sequence of nodes in L (steps 6011 and 6012) and if all child nodes of the root node R have been processed (step 6020), then step 6022 checks if all the entities E in the current sub-format have been processed.

If in step 6022 all entities of the current sub-format have been considered, then the sub-patterns of the flattened regular expression tree successfully match the current sub-format, as indicated at step 6024, the procedure 6002 terminates. Otherwise the match fails as indicated at step 6026.

Where the sub-patterns of the flattened regular expression tree do not match the current sub-format, and all sub-formats have been considered as determined at step 6052, then the overall procedure 5004 (FIG. 6A) exits in failure via step 6056, otherwise the next sub-format is selected at step 6060 and the procedure 5004 returns to step 6010.

Where step 6028 determines that all entities of the current sub-format have been considered, step 6026 follows. Otherwise, the procedure 6002 advances to the next entity E at step 6030 and initialises L and Lsᵢ with the next child node of the root node R and its lists of state sequence pairs respectively. Step 6011 then follows.

If step 6024 indicates a match, then step 6050 follows and step 6054 indicates a match, thereby ending the procedure 5004.

In the foregoing description of the preferred procedure 5004 for determining whether a regular expression tree represents a given data format, it has been assumed that the root node of the regular expression tree is a SEQ node. The procedure can also be applied if the root node is a leaf node or an OR node. Where the root node is a leaf node, an equivalent regular expression tree can be constructed to contain a root SEQ node comprising the root node of the original tree as its sole child node. The previously described procedure can then be applied without modifications. For the case where the root node is an OR node, the procedure is applied independently to the subtree rooted at each of its immediate child nodes of the root node. The overall regular expression tree is deemed to represent the given data format only if each and every such subtree represents the data format.

Although the above describes a method that operates on a single data format, the approach can be readily extended to identify whether a regular expression represents one or more of a plurality of pre-determined data formats.

### EXAMPLE

The following is an example illustrating the operation of the regular expression tree analysis process described above. Consider the problem of identifying whether the regular expression “/d{1,8}k?g” specifies a weight measurement. A regular expression tree 7000 representation of this expression is shown in FIG. 7. As the tree is already a fully flattened regular expression tree, no further trees need to be constructed. Assume that the (simplified) data format for weight measurements contains a single sub-format:
(number)(unit weight)
where “number” is an integer or a real number; and
   “unit weight” is one of “g”, “mg” or “kg”.

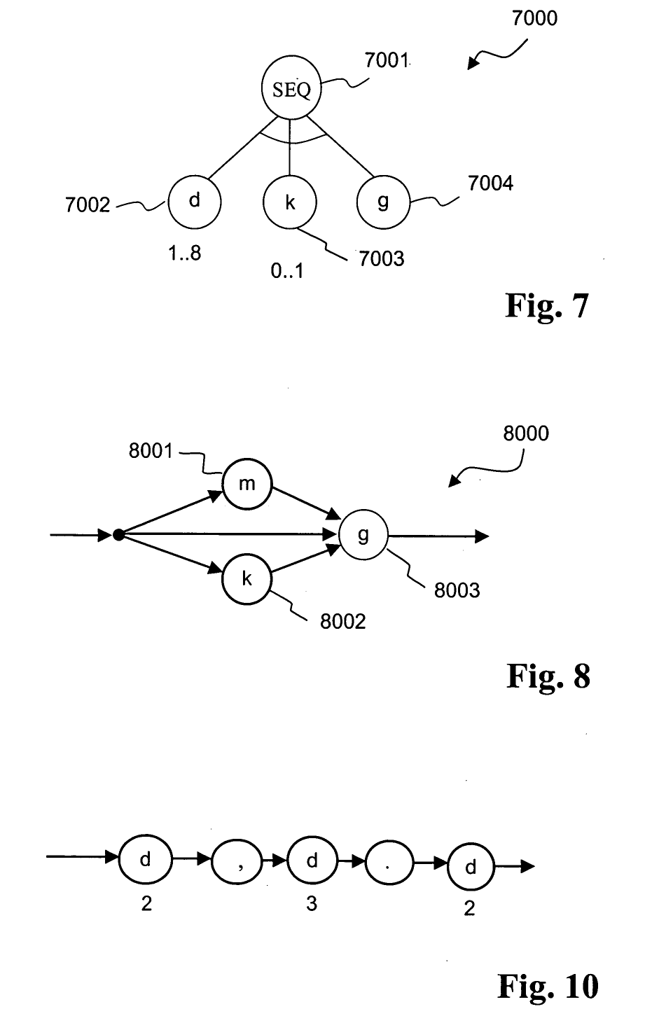

The FSMs representing “number” and “unit weight” are thus as shown in FIG. 2 and FIG. 8 respectively. By the procedure of FIG. 4A and FIG. 4B, the lists of state sequence pairs associated with a node 7002 of the regular expression tree 7000 are {(2002, 2002)} and {(2004, 2004)}. By the same procedure, nodes 7003 and 7004 each have a single list of state sequence pairs, namely {null, (8002, 8002)}, and {(8003, 8003)} respectively.

The sub-pattern matching process first attempts to match the left most sub-pattern represented by node 7002, against the first constituent part of the data format, “number”. List L is initialised to {7002}, and two lists Ls₁ and Ls₂ are created and initialised to the lists of state sequence pairs of 7002, namely
Ls₁={(2002, 2002)}
Ls₂={(2004, 2004)}.

Since “number” is a compulsory entity, and Ls₁ comprises solely the sequence pair (2002, 2002) in which state 2002 is connected to both the entry and exit points of the FSM for “number”, the match succeeds. Matching thus proceeds to the second child node 7003 and the second constituent part of the data format, “unit weight”. List L is re-initialised to {7003} and a single list Ls₁ is formed from the sole list of state sequence pairs of 7003:
Ls₁={null, (8002, 8002)}

Since “unit weight” is compulsory and the first element of Ls₁ is not a state sequence pair connected to the entry and exit points of its FSM, node 7003 on its own does not match the current entity. Processing then continues by appending the next child node 7004 to L, resulting in L={7003, 7004}, and joining its sole list of state sequence pairs {(8003, 8003)} with Ls₁. The result of the join operation is a new list Ls₁
Ls₁={(8003, 8003), (8002, 8003)}

Nodes 7003 and 7004 thus together match successfully with “unit weight” since the both elements of Ls₁ are connected to the entry and exit points of its FSM. Consequently, the regular expression “/d{1,8}k?g” is shown to represent a weight measurement.

### INDUSTRIAL APPLICABILITY

It is apparent from the above that the arrangements described are applicable to the computer and data processing industries and in particular data retrieval systems arranged for accessing heterogeneous data sources.

For example, whilst unit types such as currency and weight, have been described, other unit types such as volume and temperature may be similarly processed. Also, whilst XML schema is described in the specific examples, other predetermined schema may also be used.

The foregoing describes only some embodiments of the present invention, and modifications and/or changes can be made thereto without departing from the scope and spirit of the invention, the embodiments being illustrative and not restrictive.

1. A method of identifying data format information from a regular expression, said method comprising the steps of:
(i) constructing a regular expression tree from said regular expression;
(ii) identifying at least one sub-format of said data format, said sub-format comprising at least one constituent part;
(iii) representing each said constituent part of said at least one sub-format with a corresponding Finite State Machine, each said Finite State Machine comprising an entry point, an exit point, at least one state and zero or more transitions; and
(iv) matching said regular expression tree against said Finite State Machines to identify a matching one of said sub-formats, said one sub-format thereby representing said data format of said regular expression.

2. A method according to claim 1 wherein said matching comprises identifying all state sequence pairs from each said Finite State Machine, said state sequence pairs comprising starting and ending states linked by at least one path.

3. A method according to claim 2 wherein said matching further comprises identifying all said state sequence pairs corresponding to each leaf node of said regular expression tree, each said state sequence pair thereby forming a separate list of state sequences associated with said leaf node.

4. A method according to claim 2 wherein said matching further comprises constructing a plurality of lists of said state sequence pairs corresponding to each non-leaf node of said regular expression tree.

5. A method according to claim 4 wherein said constructing comprises propagation of state sequence pairs of child nodes of said non-leaf nodes.

6. A method according to claim 5 wherein said propagation comprises combining said state sequence pairs of said child nodes if said non-leaf node is an OR node.

7. A method according to claim 5 wherein said propagation comprises a joining operation between said state sequence pairs of said child nodes if said non-leaf node is a SEQ node.

8. A method according to claim 7 wherein said joining operation comprises sub-operations on first and second lists of state sequence pairs, said sub-operations resulting in formation of a third list of state sequence pairs.

9. A method according to claim 8 wherein said third list is formed by performing a join operation on each and every state sequence pair of said first list with each and every state sequence pair of said second list.

10. A method according to claim 8 wherein said third list comprises state sequence pairs whose starting state is the starting state of said first list and whose ending state is the ending state of said second list.

11. A method according to claim 1 wherein said regular expression tree comprises leaf and non-leaf nodes, wherein each said node is associated with a minimum instance number and a maximum instance number.

12. A method according to claim 2 wherein said matching comprises flattening said regular expression tree if a root node of said regular expression tree is a SEQ node.

13. A method according to claim 12, wherein said flattening of said regular expression tree comprises promoting grand child nodes of said root node to be immediate children of said root node if their parent is also a SEQ node and if minimum and maximum instance numbers associated with said parent node equal one.

14. A method according to claim 2 wherein if a root node of said regular expression tree is a leaf node, said matching comprises constructing and analysing a flattened regular expression tree equivalent to said regular expression tree, said flattened regular expression tree being formed by inserting a SEQ node as a parent node of said leaf node.

15. A method according to claim 2 wherein if said regular expression tree comprises a root OR node, said matching comprises constructing and analysing a plurality of flattened regular expression trees which are collectively equivalent to said regular expression tree, each said flattened regular expression tree being equivalent to a subtree rooted at a child node of said root OR node.

16. A method according to claim 15 wherein said constructing of said flattened expression trees is performed recursively.

17. A method according to claim 12 wherein said matching comprises a matching operation between child nodes of said root node and said constituent parts of said sub-format.

18. A method according to claim 17 wherein said matching operation proceeds from left to right across said regular expression tree beginning with the left most child node of said root node and the left most constituent part of said sub-format.

19. A method according to claim 17 wherein said matching operation comprises a plurality of sub-matching operations, each said sub-matching operation comprising matching at least one said child node of said root node with each said Finite State Machine representing one of said constituent parts of said sub-format.

20. A method according to claim 19 wherein said at least one child node comprises a sequence of said child nodes.

21. A method according to claim 19 wherein said matching operation succeeds if all said sub-matching operations succeed.

22. A method according to claim 19 wherein said matching comprises identifying all state sequence pairs from each said Finite State Machine, said state sequence pairs comprising starting and ending states linked by at least one path and constructing a plurality of lists of said state sequence pairs corresponding to each non-leaf node of said regular expression tree, and wherein said sub-matching operation succeeds if said one constituent part is optional and at least one of lists of said state sequence pairs of said child node contains either a null state sequence pair, state sequence pairs whose starting state is connected to said entry point of said Finite State Machine and whose ending state is connected to said exit point of said Finite State Machine, or both.

23. The method according to claim 19 wherein said matching comprises identifying all state sequence pairs from each said Finite State Machine, said state sequence pairs comprising starting and ending states linked by at least one path and constructing a plurality of lists of said state sequence pairs corresponding to each non-leaf node of said regular expression tree, and wherein said sub-matching operation succeeds if said one constituent part is compulsory and at least one of the lists of said state sequence pairs of said child node contains solely state sequence pairs whose starting state is connected to said entry point of said Finite State Machine and whose ending state is connected to said exit point of said Finite State Machine.

24. The method according to claim 1 wherein said step of identifying data format information is used to identify one or more of a plurality of pre-determined data formats.

25. A method of identifying data-format information, said method comprising the steps of:
(a) matching a regular expression described in schema with data sub-formats; and
(b) identifying a ‘type’ of the regular expression based on a result of step (a).

26. A method according to claim 25, wherein said schema is a predetermined schema and includes XML schema.

27. A method according to claim 25, wherein the type is one of currency, weight, volume, temperature and length.

28. A method according to claim 25, wherein each said data sub-format corresponds to a Finite State Machine and step (a) matches said regular expression with said Finite State Machines to thereby enable step (b) to identify the type of said data sub-format corresponding to the matching Finite State Machine.

29. A computer readable medium, having a program recorded thereon, where the program is configured to make a computer execute a procedure to identify data format information, said program comprising:
code for matching a regular expression described in schema with data sub-formats; and
code for identifying a ‘type’ of the regular expression based on a result of said matching.

30. A computer readable medium, having a program recorded thereon, where the program is configured to make a computer execute a procedure to identify data format information from a regular expression, said program comprising:
code for constructing a regular expression tree from said regular expression;
code for identifying at least one sub-format of said data format, said sub-format comprising at least one constituent part;
code for representing each said constituent part of said at least one sub-format with a corresponding Finite State Machine, each said Finite State Machine comprising an entry point, an exit point, at least one state and zero or more transitions; and
code for matching said regular expression tree against said Finite State Machines to identify a matching one of said sub-formats, said one sub-format thereby representing said data format of said regular expression.

31. Apparatus for identifying data format information from a regular expression, said apparatus:
means for constructing a regular expression tree from said regular expression;
means for identifying at least one sub-format of said data format from said regular expression tree, said sub-format comprising at least one constituent part;
means for representing each said constituent part of said at least one sub-format with a corresponding Finite State Machine, each said Finite State Machine comprising an entry point and an exit point; and
means for matching said regular expression tree against said Finite State Machines to identify a matching one of said Finite State Machines, said one Finite State Machine thereby representing said data format of said regular expression.

32. Computer apparatus for identifying data-format information, said computer apparatus comprising:
means for matching a regular expression described in schema with data sub-formats; and
means for identifying a ‘type’ of the regular expression based on a result of the matching.
